(19) United States
(12) Patent Application Publication
(10) Pub. No.: US 2008/0245423 A1
(43) Pub. Date: Oct. 9, 2008

(54) FUEL SUPPLY DEVICE

(75) Inventors: Tetsushi NODA, Chiyoda-ku (JP); Minoru TAKATA, Chiyoda-ku (JP); Hideo MITSUDO, Chiyoda-ku (JP); Shigeki KANAMARU, Chiyoda-ku (JP)

Correspondence Address: SUGHRUE MION, PLLC, 2100 PENNSYLVANIA AVENUE, N.W., SUITE 800, WASHINGTON, DC, 20037, US

(73) Assignee: Mitsubishi Electric Corporation, Tokyo (JP)

(21) Appl. No.: 11/869,414

(22) Filed: Oct. 9, 2007

(30) Foreign Application Priority Data
Apr. 6, 2007 (JP) 2007-100526

(51) Int. Cl. B60K 15/03; F02M 37/04

(52) U.S. Cl. 137/565.01; 220/501

(57) ABSTRACT

A vehicle-use fuel supply device includes a fuel tank, a support base body, a reservoir cup which is mounted on the support base body and mounts a fuel pump, a case portion which incorporates a high-pressure filter, and a discharge pipe which is mounted on the case portion and discharges the fuel discharged from the case portion to the outside. The reservoir cup is provided with a first opening portion which allows the fuel to flow into the reservoir cup and to be stored in the reservoir cup, a second opening portion which allows the stored fuel to flow out to the strainer, and a bottomed vessel having a cutout portion in a portion thereof and mounted on the reservoir cup in a state that the vessel covers the second opening portion.

### BACKGROUND OF THE INVENTION

1. Field of the Invention

The present invention relates to a vehicle-use fuel supply device which supplies fuel in the fuel tank to an injector of a vehicle-use internal combustion engine or the like under pressure, and more particularly to the structure of a vehicle-use fuel supply device which can stably supply fuel under pressure even when an oil surface of the fuel is changed due to sudden braking or the like.

2. Description of the Related Art

In trapping foreign matters such as dirts which are included in fuel and stably supplying this fuel into an injector of a fuel injection device mounted on an engine, for example, a following technique has been well-known. That is, first of all, using a relatively coarse meshed strainer made of nylon or the like which is mounted on a suction portion of a fuel pump, the foreign matters in the inside of a fuel tank are removed. Then, the foreign matters which passed through the strainer or which was generated in a motor portion constituting the fuel pump and containing wear powder of a brush, a commutator and the like is trapped by a high-pressure filter, for example, a paper-made filter element which is arranged downstream of the fuel pump (meaning a next stage of the fuel pump in view of a fuel flow passage).

Here, the above-mentioned strainer is positioned at an uppermost stream in the fuel supply passage, and hence, to enable the supply of the fuel even when the fuel in the inside of the fuel tank becomes small in amount, the strainer is positioned at a lowermost portion of the fuel tank in general. On the other hand, a motorcycle is particularly required to satisfy a condition that even when an oil surface is changed due to acceleration, deceleration or a change of posture when the fuel is small in amount, the fuel pump can surely suck the fuel without being influenced by these factors. Not to mention, this requirement is necessary for preventing a so-called discontinuous combustion phenomenon of an engine in which at the time of deceleration or descending traveling or the like, small residual fuel moves to a front side of the fuel tank and hence, the strainer is exposed from the oil surface of the fuel whereby even when an acceleration handle is turned, a rotational speed of the engine is not increased thus failing to achieve the acceleration. In view of the above circumstances, following various proposals have been made as counter measures to prevent such a discontinuous combustion phenomenon heretofore.

That is, first of all, there has been proposed the constitution in which a fuel pump and a suction filter are mounted on a cup which has an upper end thereof opened, an opening having a diameter smaller than an inner diameter of the cup is formed in a bottom of the fuel tank, and the cup is mounted on a fuel tank. Due to such a constitution, fuel which is reserved in the inside of the cup is prevented from returning to the inside of the fuel tank by a peripheral portion of the opening (see patent document 1, JP-A-2000-72074).

Further, there has been also proposed the constitution which allows small residual fuel to be reserved in a region including a center portion of a bottom plate of a fuel tank and, at the same time, a fuel suction port of a fuel pump is arranged such that the fuel suction port is positioned at approximately center in the width wise direction and in the longitudinal direction of the fuel tank (see patent document 2, JP-A-2005-248731).

Still further, there has been also proposed the constitution which, for decreasing a change of a liquid surface in the vicinity of a strainer, arranges a partition wall formed of a relatively deformable resilient member such as rubber which covers a suction port, a strainer and a front side of a fuel absorbing member (see patent document 3, JP-A-11-93794).

As can be clearly understood from the above-mentioned patent document 1 or 2, by suitably designing a shape of the fuel tank and the arrangement position of the fuel pump including the strainer, it is possible to prevent the discontinuous combustion phenomenon of the engine to some extent. However, such designing of the arrangement position of the fuel pump not only limits a shape of the fuel tank or the fuel pump but also inevitably obstructs a layout around the fuel tank and hence, such a counter measure is hardly considered realistic. Particularly, in case of a motorcycle, in addition to the limitation imposed on the height direction of the fuel tank, the motorcycle is requested to satisfy demands such as the arrangement of the fuel pump including the strainer at a position as rear as possible from the fuel tank in view of shifting of the fuel rearward in the acceleration, and the acquisition of the degree of freedom to some extent with respect to a mounting position of a hose toward an injector or a hose from a pressure regulator. Eventually, the motorcycle is still required to prevent the discontinuous combustion phenomenon of the engine even under these restricting conditions.

In this respect, patent document 3 discloses the counter measure under the above-mentioned restricting conditions and hence, it is understood that patent document 3 discloses the more realistic counter measure. However, the partition wall disclosed patent document 3 merely covers the front side of the vehicle and hence, there exists high possibility that the partition wall can not cope with splashing of the fuel in the rearward direction due to the acceleration after deceleration thus giving rise to a drawback that the discontinuous combustion phenomenon of the engine can not be completely prevented.

The present invention has been made to overcome the above-mentioned drawbacks and it is an object of the present invention to provide a vehicle-use fuel supply device which can prevent a discontinuous combustion phenomenon of an engine even when a strainer is exposed from an oil surface without being restricted by a shape of a fuel tank.

### SUMMARY OF THE INVENTION

A vehicle-use fuel supply device according to the present invention includes a fuel tank which stores fuel therein; a support base body which is mounted on the fuel tank by way of a flange portion and has a substantially L-shape in a mounting state; a reservoir cup which is mounted on the support base body and mounts a fuel pump for sucking fuel through a strainer thereon; a case portion which is mounted on the support base body and incorporates a high-pressure filter which filters the fuel passing through the fuel pump; and a discharge pipe which is mounted on the flange portion and discharges the fuel discharged from the case portion to the outside, wherein the reservoir cup is provided with a first opening portion which allows the fuel to flow into the reservoir cup and to be stored in the reservoir cup, a second opening portion which allows the stored fuel to flow out to the strainer, and a bottomed vessel having a cutout portion in a portion thereof and mounted on the reservoir cup in a state that the vessel covers the second opening portion.

As has been explained above, the present invention can prevent the occurrence of the engine discontinuous combustion phenomenon even when the fuel moves rearward due to acceleration after deceleration, not to mention, the movement of the fuel frontward at the time of descending traveling or deceleration and hence, the reliability is increased and the shape of the fuel tank is not restricted whereby it is possible to provide the vehicle-use fuel supply device which exhibits high general-use property.

The foregoing and other object, features, aspects, and advantages of the present invention will become more apparent from the following detailed description of the present invention when taken in conjunction with the accompanying drawings.

### BRIEF DESCRIPTION OF THE DRAWINGS

FIG. 1 is a cross-sectional view showing a state that a vehicle-use fuel supply device of an embodiment of the present invention is arranged in the inside of a fuel tank;

FIG. 2A is a front view of the fuel supply device 1 in FIG. 1, and FIG. 2B is a left side view of the fuel supply device 1 in FIG. 1; and

FIG. 3 is an exploded perspective view of the fuel supply device in FIG. 1.

### DESCRIPTION OF THE PREFERRED EMBODIMENTS

### Embodiment 1

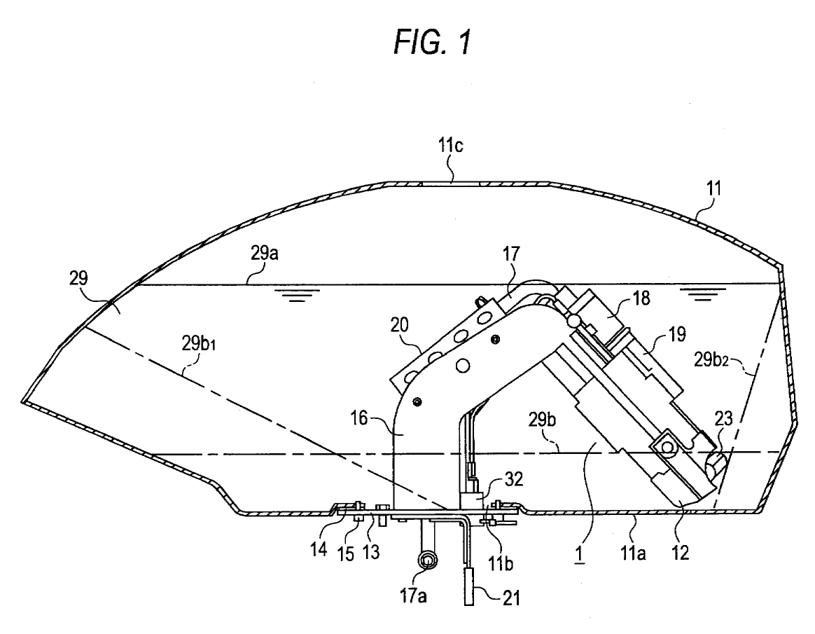

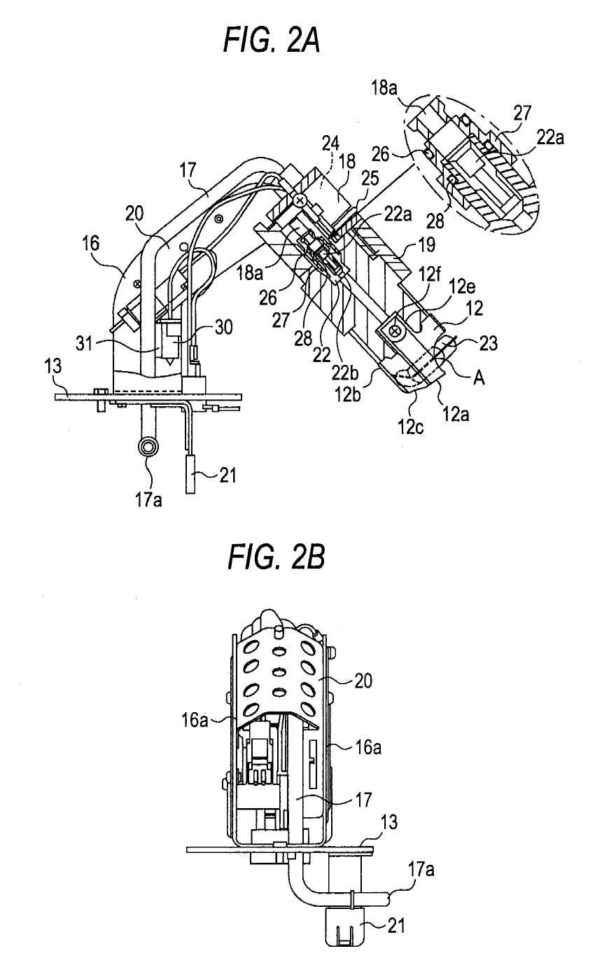

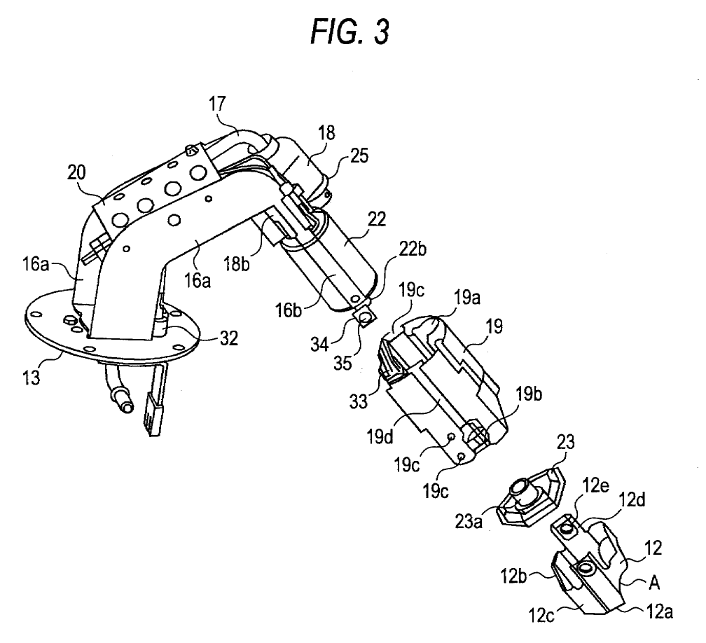

FIG. 1 is a cross-sectional view showing a state that a vehicle-use fuel supply device 1 of an embodiment 1 of the present invention (hereinafter, referred to as a fuel supply device) is arranged in the inside of a fuel tank of a vehicle, for example, a motorcycle, and FIG. 2A is a front view of the fuel supply device 1 in FIG. 1, FIG. 2B is a left side view of the fuel supply device 1 in FIG. 1. Here, out of the above-mentioned drawings, the front view is shown by cutting out or omitting some parts of the fuel supply device 1 for explicitly showing the inside of the fuel supply device 1. Further, FIG. 3 is an exploded perspective view of the fuel supply device 1 in FIG. 1.

As shown in FIG. 1, the fuel supply device 1 has, in a mounted state, a configuration of an approximately L-shape which is rotated in the clockwise direction by 120 degrees. The fuel supply device 1 has a vessel 12 side described later which is positioned at one end portion thereof inserted into a fuel tank 11 of the motorcycle through an opening portion 11b formed in a bottom portion 11a of the fuel tank 11. After literally rotating the fuel supply device 1 by 120 degree, a flange portion 13 formed on another end of the fuel supply device 1 is fixed to the bottom portion 11a of the fuel tank 11 using bolts 15 by way of a packing 14 thus mounting the fuel supply device 1 on the fuel tank 11 while closing the opening portion 11b. A stay 16 which constitutes a support base body and a discharge pipe 17 are mounted on the flange portion 13 by welding, wherein a case portion 18 and a reservoir cup 19 described later are mounted on the stay 16. On the other hand, the discharge pipe 17 is pushed into the case portion 18 and, at the same time, a fuel hose not shown in the drawing is connected to a discharge port 17a, and the fuel hose is connected to an injector also not shown in the drawing.

The stay 16 is integrally formed of a pair of side plates 16a which face each other, wherein the side plates 16a have an approximately L-shape and are continuously formed in an approximately U-shape (see FIG. 2B). A guard 20 is interposed between both side plates 16a so as to connect both side plates 16a. For example, the guard 20 is threadedly fixed to both side plates 16a using bolts for connecting both side plates 16a, for example. The guard 20 increases a strength of the stay 16 and, at the same time, plays a roll of protecting the discharge pipe 17 from an oil supply gun (not shown in the drawing) inserted into the fuel tank from a fuel supply port 11c formed in an upper portion of the fuel tank 11. Further, numeral 21 indicates a protective plate which is also welded to the flange portion 13. The protective plate 21, in the same manner as the guard 20, protects the discharge pipe 17. Since these guard 20 and protective plate 21 do not constitute essential parts of the present invention, the further detailed explanation of these parts is omitted.

In FIG. 2, in the case portion 18, a high pressure filter 24 is arranged for trapping wear powders of a brush, a commutator or the like which are generated in a fuel pump 22 described later and also foreign matters which are not removed by a strainer 23 described later. While fuel which passes through the high-pressure filter 24 is discharged from the discharge pipe 17, a well known pressure regulator 25 which maintains a fuel pressure at the time of discharging the fuel at a predetermined value is fitted in the case portion 18 by way of an O-ring not shown in the drawing. A fuel suction port 18a is also formed in the case portion 18, a connection pipe 27 is connected to the fuel suction port 18a by way of an O-ring 26, and a discharge port 22a of the fuel pump 22 is mounted on the connection pipe 27 by fitting by way of an O-ring 28. Due to such a constitution, the fuel pressurized by the fuel pump 22 is supplied to the high-pressure filter 24. Here, as is well-known, this pressurized fuel is sucked up through the strainer 23 mounted on a fuel suction port 22b of the fuel pump 22 (see FIG. 3).

The reservoir cup 19 has a bottomed shape having an opening portion (first opening portion) 19a on an upper portion (left end) thereof (see FIG. 3). The fuel pump 22 is covered with the reservoir cup 19 through the opening portion 19a. A through hole 19b is formed in a bottom portion of the reservoir cup 19, and a connection pipe 23a of the strainer 23 which is inserted through the through hole 19b is connectable with the fuel suction port 22b. As mentioned previously, along with an inflow of the fuel from the opened upper portion of the reservoir cup 19, the reservoir cup 19 literally plays a roll of a fuel reservoir. Not to mention, it is always necessary to make the reserved fuel reach the strainer 23. This roll is performed by a flow out port 19c (second opening portion) which is formed in the bottom portion of the reservoir cup 19. Further, as a result of maintaining the fuel pressure at a predetermined value, the fuel which becomes a surplus is discharged from the pressure regulator 25. This discharged surplus fuel is also reserved in the reservoir cup 19 and reaches the strainer 23 through the above-mentioned flow out port 19c. That is, the reservoir cup 19 also functions as a flow passage for the surplus fuel.

So long as the inside of the fuel tank 11 is filled with the fuel 29 (see FIG. 1), even when any design change is not applied to the strainer 23, the strainer 23 per se is immersed in the fuel 29 and hence, the fuel supply device does not suffer from any troubles with respect to performances as so-called “supply device”. However, as also explained in the Description of the Related Art, even when an oil surface 29a of the fuel 29 is lowered and the strainer 23 is exposed, the fuel pump 22 is required to suck the fuel 29. According to the present invention, in addition to the “fuel reservoir” action and the “fuel flow passage” action of the reservoir cup 19, the vessel 12 which forms another “reservoir portion” is added. The vessel 12 also has a bottom shape. In a state that the fuel 29 is filled in the fuel tank 11, in the drawing, to allow easy sucking of the fuel 29 from the right direction in the drawing, a cutout A is formed in portions of a bottom portion 12a and side surfaces 12b thus exposing the strainer 23. Here, on a left side of the drawing, connection surfaces 12c which connect the bottom portion 12a and the side surfaces 12b are formed (see FIG. 2A), and these connection surfaces 12c are arranged close to an inner surface of the bottom portion 11a of the fuel tank 11 (see FIG. 1). That is, the bottom portion 12a extends, in a mounted state of the fuel supply device 1, in the right upper direction to become substantially parallel to the bottom portion of the fuel tank thus preventing falling of the fuel from the vessel 12. Here, numeral 30 indicates a well-known thermistor for detecting the oil surface 29a which is mounted on the flange portion 13 by way of a support plate 31.

Next, assembling steps of the fuel supply device 1 is explained in conjunction with FIG. 3. After mounting the fuel pump 22 and the pressure regulator 25 on the case portion 18, the guide 18b of the case portion 18 is inserted into a pair of distal ends 16b of the stay 16, and the guide 18b is slid to a vending point of the stay 16. The discharge pipe 17 is pushed into the case portion 18, and a lead line from the fuel pump 22 is connected to a connector 32 mounted on the flange portion 13 thus assembling a half finished product around the flange portion 13 in the drawing. Thereafter, guides 19d of the reservoir cup 19 are also inserted into the pair of distal ends 16b of the stay 16, and the reservoir cup 19 is slid until an upper surface of the reservoir cup 19 abuts a lower surface of the case portion 18. Here, a lid 33 is interposed on a side close to the bottom surface of the fuel tank such that the lid 33 covers a portion of the opening portion 19a formed in the upper surface of the reservoir cup 19. Due to such a constitution, an abutting surface which is formed only in the vicinity of the stay 16 is enlarged by the lid 33 thus preventing falling of the fuel from the left side of the reservoir cup 19 which connects both guides 19d by approximately ¼ (a side close to the bottom portion 11a of the fuel tank 11).

A portion of the guide 19d corresponding to the distal end 16b has a large width, and the large width portion is fastened to a thread-mounting portion of the distal end 16b using bolts 35 by way of a stopper plate 34 thus mounting the reservoir cup 19 and the case portion 18 on the stay 16. Then, the connection pipe 23a is inserted to the fuel suction portion 22b to mount the vessel 12. The vessel 12 includes a pair of projecting portions 12d having spring property which extends from side surfaces 12b thereof, and the projecting portions 12d include engaging holes 12e. That is, the projecting portions 12d project toward head portions of the bolts 35 and are curved outwardly, and head portions of the bolts 35 are engaged with the engaging holes 12e thus realizing so-called snap fitting. Due to the above-mentioned assembling operation, the fuel supply device 1 can be mounted on the above-mentioned fuel tank 11.

The manner of operation of the fuel supply device 1, particularly the fuel supply operation is performed in a well-known manner. That is, when the fuel pump 22 is driven through the connector 32, due to the rotation of an impeller not shown in the drawing in the fuel pump 22, the fuel 29 in the inside of the fuel tank 11 is pressurized and sucked into the fuel suction port 22b by way of the strainer 23, and is discharged from the discharged port 22a (see FIG. 2A). Then, the discharged fuel is supplied to an injector of an internal combustion engine or the like by way of the high-pressure filter 24 in the inside of the case portion 18, the discharge pipe 17 and the fuel hose not shown in the drawing. On the other hand, when the pressure of the fuel in the inside of the casing portion 18 is higher than a predetermined value, the fuel is discharged to the reservoir cup 19 by way of the pressure regulator 25 and hence, the pressure is maintained at the predetermined value.

In sucking the fuel 29 in the strainer 23, while the strainer 23 is covered with the vessel 12 as mentioned previously, on a paper surface in FIG. 2, a right upper surface of the strainer 23 is opened and hence, in a state that the fuel tank 11 is filled with the fuel 29 (see FIG. 1), it is possible to speedily and efficiently suck the fuel 29 into the periphery of the strainer 23. Further, even when the oil surface 29a is lowered (29b in the drawing), and, for example, the strainer 23 is exposed due to the inclination of a vehicle body attributed to curve traveling, by making use of a fuel residual amount from the opening 19a formed in the upper surface of the reservoir cup 19 and the above-mentioned surplus fuel from the pressure regulator 25, the pressurization and the suction of the fuel pump 22 are not obstructed. Particularly, the reservoir cup 19 also functions as the flow passage for the surplus fuel and hence, it is needless to say that this structure is preferable compared to the structure which simply returns the surplus fuel into the inside of the fuel tank 11.

With respect to the fuel residual amount in the reservoir cup 19, by providing the lid 33 (see FIG. 3) on the side close to the bottom portion 11a of the fuel tank 11, even at the time of descending traveling or deceleration (29b1 in the drawing), the lid 33 effectively performs the fuel-residual-amount maintaining function. Further, also with respect to the fuel residual amount in the vessel 12, due to the provision of the side surfaces 12b and the connection surface 12c, such a fuel residual amount can be maintained in the same manner. Further, even at the time of acceleration after deceleration (29b2 in the drawing), spreading of the fuel rearwardly can be prevented by the bottom portion 12a and hence, the fuel residual amount can be maintained in the same manner. That is, in any operation mode with the strainer 23 exposed due to lowering of the oil surface 29a, it is possible to expect the prevention of an engine discontinuous combustion phenomenon.

To obtain the above-mentioned advantageous effects, the provision of the lid 33 is indispensable. In providing the lid 33, as can be clearly understood from FIG. 3, the lid 33 has a necessary-minimum shape for achieving the prevention of falling of the fuel and hence, mounting of the fuel pump 22, that is, assembling of the fuel pump 22 into the inside of the reservoir cup 19 is facilitated. Further, along with the above-mentioned mounting of the vessel 12 by snap fitting, the fuel supply device of the present invention is sufficiently comparable to the conventional fuel supply device in easiness of assembling. Still further, in this embodiment 1, in view of a height of a part integration ratio around particularly the engine of the motorcycle, the case in which the bottom portion 11a of the fuel tank 11 is made flat is explained. However, even when the shape of the bottom portion is not flat, that is, even when a fuel reservoir portion is formed on the bottom portion by expecting reserving of the fuel to some extent, it is possible to cope with such a situation by merely changing a shape of the stay 16 which conforms to the situation. This is particularly attributed to the fact that, as can be clearly understood from the explanation made heretofore, the fuel supply device 1 is configured to mount substantially whole respective members such as the fuel pump 22 including the strainer 23, the case portion 18 (high-pressure filter 24, pressure regulator 25), the reservoir cup 19 (vessel 12), the thermistor 30 and the guard 20 on the stay 16. That is, by merely changing the stay 16, it is possible to provide the fuel supply device which exhibits high general-use property which can cope with fuel tanks of various shapes to users. Here, in the above-mentioned explanation, the pressure regulator 25 is mounted in the high-pressure filter 24 by fitting. However, it is not always necessary to provide such configuration to the high-pressure filter 24. For example, the pressure regulator may be arranged outside the fuel tank 11 and a return pipe from the pressure regulator may be engaged with the reservoir cup 19.

Various modifications and alterations of this invention will be apparent to those skilled in the art without departing from the scope and spirit of this invention, and it should be understood that this is not limited to the illustrative embodiments set forth herein.

What is claimed is:

1. A vehicle-use fuel supply device comprising:
a fuel tank which stores fuel therein;
a support base body which is mounted on the fuel tank by way of a flange portion and has a substantially L-shape in a mounting state;
a reservoir cup which is mounted on the support base body and mounts a fuel pump for sucking fuel through a strainer thereon;
a case portion which is mounted on the support base body and incorporates a high-pressure filter which filters the fuel passing through the fuel pump; and
a discharge pipe which is mounted on the flange portion and discharges the fuel discharged from the case portion to the outside, wherein
said reservoir cup is provided with a first opening portion which allows the fuel to flow into the reservoir cup and to be stored in the reservoir cup, a second opening portion which allows the stored fuel to flow out to the strainer, and a bottomed vessel having a cutout portion in a portion thereof and mounted on the reservoir cup in a state that the vessel covers the second opening portion.

2. A vehicle-use fuel supply device according to claim 1, wherein said case portion covers a portion of the first opening portion of the reservoir cup, and said reservoir cup forms a flow passage for a surplus fuel from a pressure regulator which sets the fuel discharged from the discharge pipe at a predetermined pressure therein.

3. A vehicle-use fuel supply device according to claim 1, wherein said vessel is mounted on the reservoir cup in a state that a portion of a bottom surface of the vessel is arranged substantially parallel to the fuel tank.

4. A vehicle-use fuel supply device according to claim 1, wherein said reservoir cup is mounted on the support base body using a bolt, and said vessel is mounted on the reservoir cup by fitting a pair of engaging holes formed in a projecting portion of the vessel on a head portion of the bolt.

5. A vehicle-use fuel supply device according to claim 1, wherein a lid is interposed between the first opening portion of the reservoir cup and the case portion on a side close to a bottom surface of the fuel tank.
